(19) United States
(12) Patent Application Publication
(10) Pub. No.: US 2025/0159434 A1
(43) Pub. Date: May 15, 2025

(54) TRACKING DEVICE ALERT GENERATION

(71) Applicant: T-Mobile Innovations LLC, Overland Park, KS (US)

(72) Inventor: Brian STARK, Denver, CO (US)

(21) Appl. No.: 18/509,761

(22) Filed: Nov. 15, 2023

(51) Int. Cl. H04W 4/029; G06Q 10/0833; G06Q 10/0836

(52) U.S. Cl. CPC H04W 4/029; G06Q 10/0833; G06Q 10/0836

(57) ABSTRACT

A method for tracking device control includes generating alerts from a network component based on a movement and location of a wireless tracking device. The method includes receiving, at an access node of a wireless network, a signal indicating a location from a tracking device and comparing the location to stored locations. The method further includes identifying the location as one of the stored locations and monitoring the tracking device for movement from the location. Responsive to detecting the movement from the stored location, the method includes sending an instruction to the tracking device to generate an alert.

### TECHNICAL BACKGROUND

A wireless network, such as a cellular network, can include an access node (e.g., base station) serving multiple wireless devices or user equipment (UE) in a geographical area covered by a radio frequency (RF) transmission provided by the access node. As technology has evolved, different carriers within the cellular network may utilize different types of radio access technologies (RATs). RATs can include, for example, 3G RATs (e.g., GSM, CDMA etc.), 4G RATs (e.g., WiMax, LTE, etc.), 5G RATs (new radio (NR)), and 6G RATs. As access nodes have evolved, networks may include a combination of multiple access node such as 4G LTE evolved NodeBs (eNodeBs or eNBs) and 5G NR next generation NodeBs (gNodeBs or gNBs) or alternatively may be exclusively 4G or 5G cellular systems.

Over time, wireless devices have been provided with tracking capabilities, such that the devices are able to report global positioning system (GPS) coordinates to the wireless networks. While this functionality can be provided in wireless devices such as smart phones, simpler and less expensive tracking devices have evolved that report to wireless networks. These simpler tracking devices do not have the extensive functionality of smart phones and instead have basic features that enable them to report their locations to a wireless network. These simpler tracking devices can be attached to possessions, such as packages, luggage, or vehicles in order to monitor their locations.

While these tracking devices have legitimate uses, they can also be used to track individuals without their knowledge. In this instance, the usage may be less legitimate. Accordingly, a need exists to provide a solution when tracking processes are being utilized for illegitimate purposes.

### OVERVIEW

Exemplary embodiments described herein include systems, methods, processing nodes, access nodes, and non-transitory computer readable mediums for providing alert generation for tracking devices. An exemplary method includes receiving, at an access node of a wireless network, a signal indicating a location from a tracking device. The method additionally includes comparing the location to stored locations and identifying the location as one of the stored locations. The method further includes monitoring the tracking device for movement from the location. Responsive to detecting the movement from the stored location, the method includes sending an instruction to the tracking device to generate an alert while the tracking device is enabled.

An additional exemplary embodiment includes a system configured for alert generation for tracking devices. The system includes a memory storing data and instructions. The system further includes a processor accessing the memory to execute the stored instructions and perform multiple operations. The operations include comparing the location to stored locations in the memory and identifying the location as one of the stored locations. The operations additionally include monitoring the tracking device for movement from the location and responsive to detecting movement from the stored location, sending an instruction to the tracking device to generate an alert.

An additional exemplary embodiment includes an access node including a memory storing data and instructions. The access node further includes a transceiver receiving a signal indicating a location of a tracking device and a processor accessing the memory to execute the stored instructions and perform multiple operations. The operations include comparing the location to stored locations in the memory and identifying the location as one of the stored locations. The operations additionally include monitoring the tracking device for movement from the location and responsive to detecting movement from the location, generating an instruction for the tracking device to generate an alert.

Additional exemplary embodiments include processing nodes and non-transitory computer-readable mediums performing the exemplary methods. For example, a non-transitory computer readable medium or processing node may be provided generating an instruction to provide an alert for sending to a tracking device. The non-transitory computer-readable medium or processing node stores instructions executed by a processor to perform the multiple operations.

### BRIEF DESCRIPTION OF THE DRAWINGS

FIG. 1 depicts an exemplary operating environment in accordance with the disclosed embodiments.

FIG. 2 depicts an exemplary tracking device controller in accordance with disclosed embodiments.

FIG. 3 depicts an exemplary access node in accordance with disclosed embodiments.

FIG. 4 depicts an exemplary tracking device in accordance with disclosed embodiments.

FIG. 5 is a flow chart illustrating a method for generating alerts for a tracking device in accordance with one disclosed embodiment.

FIG. 6 is a flow chart illustrating additional details of a method for generating alerts for a tracking device in accordance with a disclosed embodiment.

FIG. 7 is a flow chart illustrating a method for generating alerts at a tracking device in accordance with a disclosed embodiment.

FIG. 8 is a diagram illustrating an exemplary environment for generating alerts at a tracking device in accordance with a disclosed embodiment.

### DETAILED DESCRIPTION

Exemplary embodiments described herein include systems, methods, access nodes, processing nodes, wireless trackers, and computer readable mediums for causing an alert to be generated on a wireless tracking device.

The generation of alerts may be based on a comparison of a tracker location with a stored location to identify the location as a destination location. For example, stored locations may include post offices boxes or shipping drop boxes. If the tracker is affixed to a package mailed to a Post Office Box, the location of the Post Office Box is stored as a destination location. Thus, optimally, once the tracker reaches its destination location or when the tracker is removed from its destination location, the tracker can be disabled to avoid tracking without consent of an individual or entity retrieving the package from its destination.

Generally, the tracker or tracking device is paired with a mobile device. The user of the mobile device can control and monitor the tracker, typically through a mobile application associated with the tracker. However, trackers operating over the mobile network can also be controlled and monitored by network components. Accordingly, embodiments described herein provide a method and system for using the network components to control and monitor the tracking device. In embodiments provided herein, network components monitor the location of the tracking device, compare the location of the tracking device with stored locations and monitor the tracking device for further movement. Upon detecting further movement of the tracking device, the network components may notify the mobile user paired with the wireless tracking device and provide the mobile user with an opportunity to disable the tracking device. If the tracking device is not disabled, the network components may cause the tracking device to generate an alert in order to prevent individuals or entities in possession of the tracking device from being tracked without prior consent.

While any shipping destinations may be utilized as stored locations, PO boxes and shipping drop boxes provided by, for example, FedEx® or UPS®, may often be utilized by package recipients in order to avoid providing the sender with an actual residential address. Thus, should a package housing a wireless tracking device be removed from the shipping facility and taken to the recipient's residential address or other private location, the recipient's privacy would be compromised. Sending a tracking device to a recipient via a PO box or other parcel-holding service has been a method used to determine the recipient's physical address in hopes that the recipient unsuspectingly picks up the package and takes it home. Since the GPS location data is transmitted in real-time, the physical location would then be revealed before discovery of the tracking device in the package. Notifying the recipient of the device's presence via an audible beep, a vibration, a flashing indicator or another method allows the recipient to take appropriate action.

Since the tracking device continuously transmits its location, network components can determine if the tracking device has arrived at a shipping location (e.g., post office, UPS or FedEx facility, etc.). Once the tracking device is flagged as potentially being in a shipment at the shipping location, network components may alert the device owner that a shipment has been detected and present the tracking device owner with an option to confirm that a legitimate use case of the device is to further track the shipment or prevent the tracking device owner with a way to disable the tracking device temporarily or permanently. This allows the shipper to stop tracking if the shipment was accidental, unauthorized, or if the shipping drop box is the final destination. If the device is not disabled, and movement from the shipping location is detected, the network components attempt to alert the package carrier of the presence of the tracker via a distinct audio tone or another method, such as Bluetooth broadcasts that external devices such as phones with appropriate software or other specialized devices for shippers, could detect.

An exemplary environment described herein includes a tracking device controller, at least an access node (or base station), such as an eNodeB, or gNodeB, a tracking device, as well as an end-user wireless device. For illustrative purposes and simplicity, the disclosed technology including the tracking device controller will be illustrated and discussed as being implemented responsive to the communications between an access node (e.g., a base station) and a wireless tracking device. Further, multiple access nodes may be utilized. For example, some wireless tracking devices may communicate with an LTE eNodeB and others may communicate with an NR gNodeB.

In addition to the systems and methods described herein, the operations for controlling the tracking device by generating alerts may be implemented as computer-readable instructions implemented by an access node or other network nodes such as processing nodes. The processing node may include a processor included in the access node or a processor included in any controller node in the wireless network that is coupled to the access node.

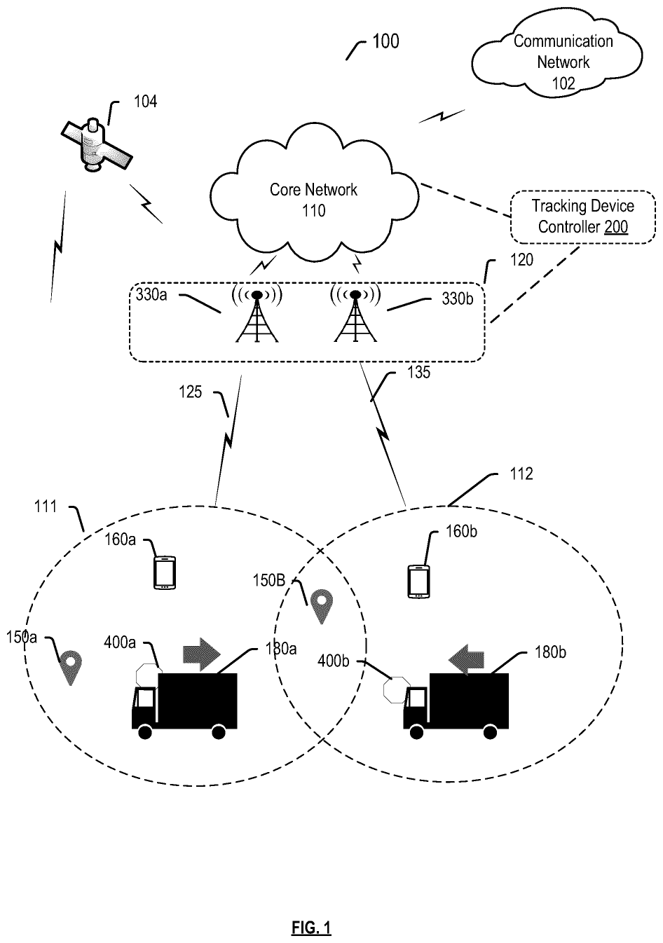

FIG. 1 depicts an exemplary communication network 100. A core network 110 is coupled to a radio access network (RAN) 120 including access nodes 330a, 330b. The core network 110 and RAN 120 serve wireless devices 160a, 160b over communication links 125 and 135. The wireless devices 160a, 160b can include end-user wireless devices (e.g., UEs). The core network 110 and RAN 120 also communicate with wireless tracking devices 400a, 400b. As illustrated, the wireless tracking devices 400a, 400b, may be affixed to vehicles 180a 180b or to packages traveling within the vehicles 180a, 180b. Although the vehicles 180a, 180b are shown as trucks, any suitable vehicles such as trains, aircrafts, or other vehicles may be utilized to transport items tracked using wireless device trackers 400a, 400b. Further, GPS satellites 104 transmits signals that are received by the wireless tracking devices 400a, 400b, the wireless devices 160a, 160, and the base stations 330a, 330b.

The communication links 125 and 135 may use 5G NR, 4G LTE, 6G, or any other suitable type of radio access technology (RAT). Core network 110 can be structured as an evolved packet core (EPC) network or as a 5G core using a service-based architecture (SBA) utilizing core network functions and elements, including, for example, user plane functions (UPF) control plane functions (CPF). The core network 110 provides access to a communication network 102, such as the Internet or other packet data network.

The RAN 120 can include various access network functions and devices disposed between the core network 110 and the wireless devices 160a, 160b and the wireless tracking devices 400a, 400b. For example, the RAN 120 includes access nodes or base stations 330a, 330b. The access nodes or base stations 330a, 330b may be or include eNodeBs and/or gNodeBs communicating with the plurality of wireless devices 160a, 160b and the wireless tracking devices 400a and 400b. The access nodes 330a, 330b may operate within coverage areas 111 and 112 by deploying the links 125 and 135 respectively. The wireless links 125 and 135 may correspond to the same or different RATs, frequency bands, or bandwidths. Coverage areas 111 and 112 are shown as having a defined boundary and signal parameters may vary between the access nodes 330a, 330b and the boundaries of the coverage areas 111 and 112.

It is understood that the disclosed technology may also be applied to communication between an end-user wireless device 160a, 160b, wireless tracking devices 400a, 400b, and other network resources, depending on the RAT and network technology being implemented. Further, either of core network 110 and RAN 120 can include one or more of a local area network, a wide area network, and an internetwork (including the Internet) capable of communicating signals and carrying data, for example, to support voice, push-to-talk, broadcast video, and data communications by wireless devices 160a, 160b and wireless tracking devices 400a, 400b . . . . Alternatively or additionally to the UPF and CPF, the illustrated network topology can include packet gateways, such as a CUPS based user plane S-GW, P-GW, or SAE-GW.

The core network 110 may incorporate many functions not shown in FIG. 1. For example, the CPF may include but are not limited to a Network Slice Selection Function (NSSF), a Network Exposure Function (NEF), a NF Repository Function (NRF), a Policy Control Function (PCF), a Unified Data Management (UDM), an Application Function (AF), a Short Message Service Function (SMSF), a Core Access and Mobility management Function (AMF), a Session Management Function (SMF), and an Authentication Server Function (AUSF). The UPF may also include, for example, a Unified Data Repository (UDR).

Communication network 102 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 102 can be capable of carrying data, for example, to support voice, push-to-talk, broadcast video, and data communications by wireless devices 160a, 160b. Wireless network protocols can comprise Multimedia Broadcast Multicast Services (MBMS), code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), or 6G. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

The exemplary operating environment 100 may further include a tracking device controller 200, which is illustrated as operating between the core network 110 and the RAN 120. However, it should be noted that the tracking device controller 200 may operate in the core 110, in the RAN 120 or may be distributed. For example, the tracking device controller 200 may utilize components located at both the core network 110 and at the multiple access nodes 330a, 330b. Alternatively, the tracking device controller 200 may be an entirely discrete system operating in conjunction with the RAN 120, core 110 and/or the wireless devices 160a, 160b.

The tracking device controller 200 receives information including location data from the wireless tracking devices 400a, 400b. The wireless tracking devices 400a, 400b may transmit GPS coordinates at regular intervals, for example, every ten seconds, to the access node 330a, 330b, for use by the tracking device controller 200. For example, the tracking device controller 200 may store location information and compare the location information received from the wireless tracking devices 400a, 400b, to the stored location information. Further, the tracking device controller 200 can determine when the wireless tracking device 400a, 400b is moving and when it is stationary. Based on these determinations, the wireless tracking controller 200 can cause the wireless tracking devices 400a, 400b to generate alerts.

Wireless devices 160a, 160b may be any device, system, combination of devices, or other such communication platform capable of communicating wirelessly with RAN 120 using one or more frequency bands deployed therefrom. Each of the wireless devices 160a, 160b may be, for example, a mobile phone, a wireless phone, a wireless modem, a personal digital assistant (PDA), a voice over internet protocol (VOIP) phone, a voice over packet (VOP) phone, or a soft phone, as well as other types of devices or systems that can exchange audio or data via RAN 120. Wireless devices 160a, 160b may also include, for example Internet of Things (IoT) devices or home internet (HINT) devices.

Other network elements may be present to facilitate communication but are omitted for clarity, such as base stations, base station controllers, mobile switching centers, dispatch application processors, and location registers such as a home location register or visitor location register. Components not specifically shown in FIG. 1 can further include processing nodes, controller nodes, routers, gateways, and physical and/or wireless data links for communicating signals among various network elements, additional base stations, controller nodes, telephony switches, internet routers, network gateways, computer systems, communication links, or other type of communication equipment, and combinations thereof.

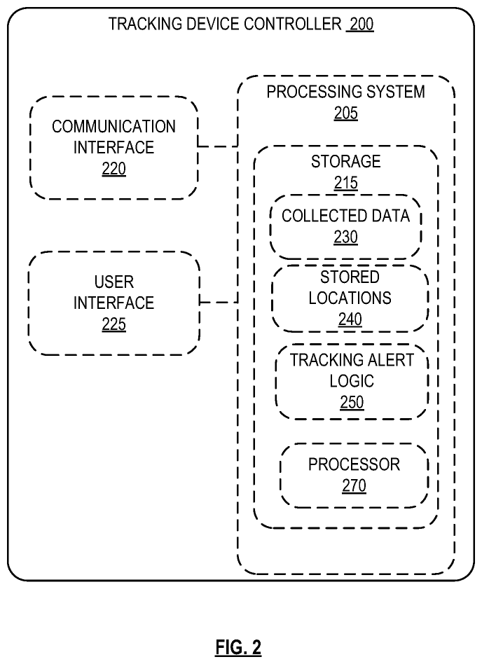

FIG. 2 illustrates a tracking device controller 200 in accordance with embodiments described herein. The components described herein are merely exemplary as many different configurations for the tracking device controller 200 may be implemented. The tracking device controller 200 may be configured to perform the methods and operations disclosed herein to cause wireless tracking devices 400a, 400b to generate alerts and/or to notify paired mobile devices 160a, 160b of the disposition of the wireless tracking device 400a, 400b and the intent to generate alerts. In the disclosed embodiments, the wireless tracking controller 200 may be integrated with each access node 330a, 330b, integrated with the core network 110 or may be an entirely separate component capable of communicating with at least the wireless tracking devices 400a, 400b and the RAN 120.

The tracking device controller 200 may be configured for collecting data transmitted by the wireless tracking devices 400a, 400b to the access nodes 330a, 330b. To control the wireless tracking devices 400a, 400b, the tracking device controller 200 may utilize a processing system 205. Processing system 205 may include a processor 210 and a storage device 215. Storage device 215 may include a RAM, ROM, disk drive, a flash drive, a memory, or other storage device configured to store data and/or computer readable instructions or codes (e.g., software). The computer executable instructions or codes may be accessed and executed by processor 205 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein. For example, tracking alert logic 250 may include instructions for causing the wireless tracking devices 400a, 400b to generate alerts. The tracking alert logic 250 may leverage collected data 230 received from the wireless tracking devices 400a, 400b and stored locations 240 for determining when alert generation instructions should be transmitted to the wireless tracking devices 400a, 400b. Further, the tracking alert logic 250 may utilize the collected data 230 and the stored locations 240 to determine when to send a notification to paired wireless devices 160a, 160b offering an option to disable the paired wireless tracking devices 400a, 400b.

To perform the above-described operations, the tracking alert logic 250 may be executed by the processor 270 to operate on the collected data 230. The access technology may include, for example, 4G LTE, 5GSA, 5G NSA, or 6G. Processor 270 may be a microprocessor and may include hardware circuitry and/or embedded codes configured to retrieve and execute software stored in storage device 215. The tracking device controller 200 further includes a communication interface 220 and a user interface 225. Communication interface 220 may be configured to enable the processing system 205 to communicate with other components, nodes, or devices in the wireless network. For example, the tracking device controller 200 receives relevant parameters from an access node 330a, 330b or from the wireless tracking devices 400a, 400b.

Communication interface 220 may include hardware components, such as network communication ports, devices, routers, wires, antenna, transceivers, etc. User interface 225 may be configured to allow a user to provide input to the tracking device controller 200 and receive data or information from access node 330a, 330b, the wireless devices 160a, 160b, and the wireless tracking devices 400a, 400b. User interface 225 may include hardware components, such as touch screens, buttons, displays, speakers, etc. The tracking device controller 200 may further include other components such as a power management unit, a control interface unit, etc.

The location of the tracking device controller 200 may depend upon the network architecture. As set forth above, the tracking device controller 200 may be located in the core network 110, in a separate processing node, in the RAN 120, in multiple locations or may be an entirely discrete component. Further, although shown as a single integrated system, the functions of data collection and storage and alert generation may be separated and disposed in separate locations.

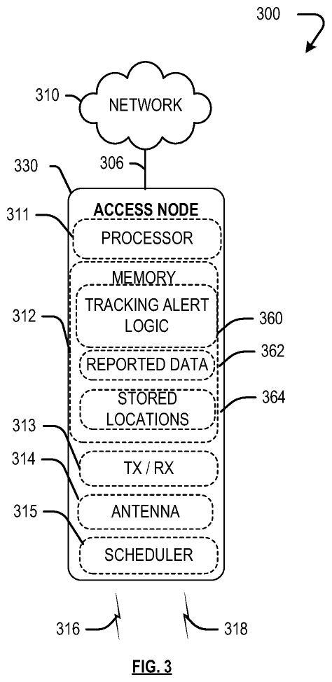

FIG. 3 illustrates an operating environment 300 for an exemplary access node 330 in accordance with the disclosed embodiments. In exemplary embodiments, access node 330 can include, for example, a gNodeB or an eNodeB. Access node 330 may comprise, for example, a macro-cell access node, such as access nodes 330a and 330b described with reference to FIG. 1. Access node 330 is illustrated as comprising a processor 311, memory 312, transceiver(s) 313, and antenna(s) 314, and scheduler 315. Processor 311 executes instructions stored on memory 312, while transceiver(s) 313 and antenna(s) 314 enable wireless communication with other network nodes, such as wireless devices described herein, and other nodes. For example, wireless devices 160a, 160b and the wireless tracking devices 400a and 400b may initiate uplink transmissions such that the transceivers 313 and antennas 314 receive messages from the wireless devices, for example, over communication links 316 and 318 and pass the messages to a mobility entity in the core network. Further, the transceivers 313 and antennas 314 receive signals from the mobility entity such as a mobility management entity (MME) or access and mobility function (AMF) and pass the messages to the appropriate wireless device 160a, 160b, and wireless tracking devices 400a, 400b. Scheduler 315 may be provided for scheduling resources based on the presence and performance parameters of the wireless devices. The access node 330 may connect over a communication link 306 to a network 310. Network 310 may be similar to core network 110 discussed above.

In embodiments provided herein, the memory 312 may further store tracking alert logic 360, reported data 362, and stored locations 364. The reported data 362 may be data collected from the wireless tracking devices 400a, 400b, such as GPS location data. Thus, a processor from the tracking device controller 200 may communicate with the access node 330 in order to receive relevant data from the reported data 362. Further, in some embodiments, the access node 330 may include tracking alert logic 360 that receives relevant instructions from the wireless tracking device controller 200 for forwarding to the wireless tracking devices 400a, 400b and/or wireless devices 160a, 160b. In other embodiments, tracking device controller 200 may be wholly incorporated in the access node 330.

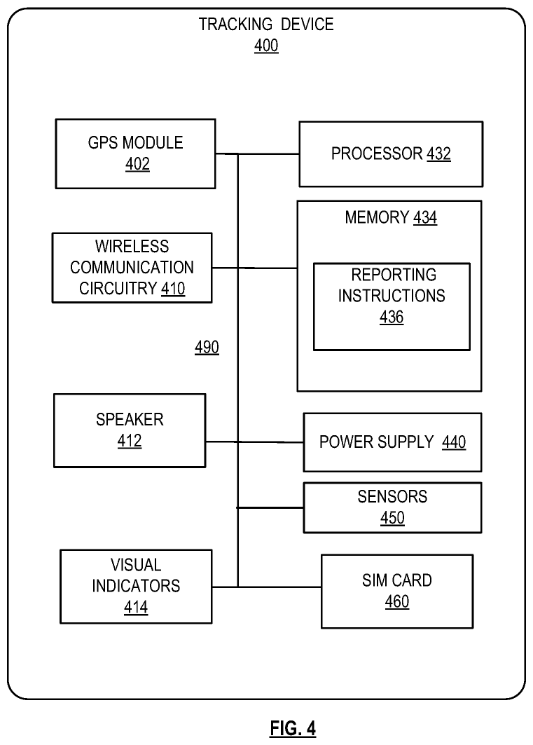

FIG. 4 depicts a wireless tracking device 400 in accordance with disclosed embodiments. The wireless tracking device 400 may correspond to one of wireless tracking devices 400a, 400b in FIG. 1. As illustrated, the wireless tracking device 400 includes a GPS module 402, wireless communication circuitry 410, a speaker 412, visual indicators 414, processor 432, memory 434, power supply 440, sensors 450, and SIM card 460. Components may be connected, for example, by a bus 490. The sensors 450 may, for example, include a light sensor. If the tracker is located inside of a package, the light sensor 450 will provide a notification when the package is opened. The speaker 412 and visual indicators 414 may be used to play sounds or flash when an item is lost.

Various components may be combined, for example, in a system on chip (SoC). A microprocessor may have a bus to communicate with memory on separate chips and buses to communicate with the rest of the equipment. These components are merely exemplary and the wireless tracking device 400 may include a larger or smaller number of components capable of performing the functions described herein.

The memory 434 may store, for example, reporting instructions 436. When executed by the processor 432, the reporting instructions 436 may cause the wireless tracking device 400 to send location information reports to the access node 330 or directly to the tracking device controller 200. The wireless communication circuitry 410 may include circuit elements configured to generate wireless signals (e.g., one or more antennas) as well as interface elements configured, for example, to translate control signals from the processor 432 into data signals for wireless output.

The wireless tracking device 400 may be controlled both by a mobile app installed on a paired wireless device and a network operator or network component. For example, the wireless tracking device may provide mobile device users and the network with device location information as frequently as every ten seconds. Further, from a paired mobile application, users can set virtual boundaries for tracked items. If the item with the affixed wireless tracking device 400 leaves the area defined by the boundary, the mobile application generates a push notification.

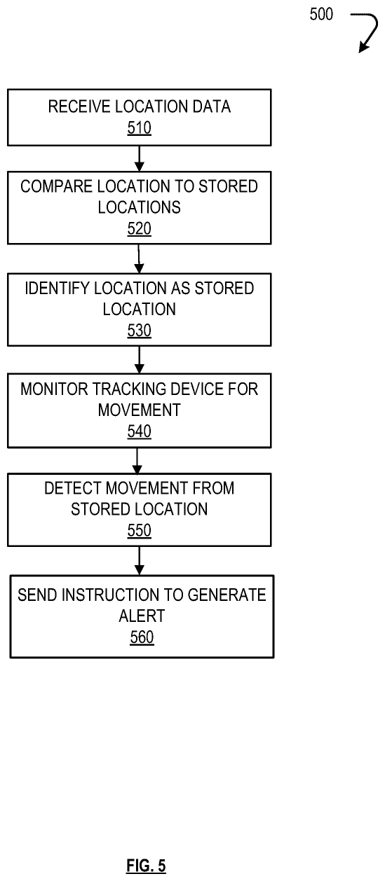

The disclosed methods for controlling a tracking device are further described below with reference to FIGS. 5-8. FIG. 5 illustrates an exemplary method 500 performed by the tracking device controller 200. Method 500 may be performed by any suitable processor discussed herein, for example, the processor 270 included in the tracking device controller 200 or any other suitable processor. For the sake of convenience, the method is described as being performed by the processor 270.

Method 500 starts in step 510, when the processor 270 receives location data indicating the position of the wireless tracker. The position of the wireless tracker 400 can be determined based on its reported location data in any known manner. The position can be determined from GPS data or from data transmitted over the wireless network or a combination of GPS and wireless data. In embodiments set forth herein, the processor 270 may collect data from every wireless tracking device in a cell or from every wireless device in multiple cells. The tracking device controller 200 may collect this data directly from the wireless tracking devices 400a, 400b or alternatively from the access nodes 330a 330b, depending on the location of the tracking device controller 200. Signals indicating the location of the wireless tracking devices 400a, 400b may include GPS coordinates.

Upon determination of the position of the wireless tracking device 400a, 400b, the tracking device controller 200 compares the location of the wireless tracking device 400a, 400b to stored locations at step 520. The stored locations may be stored, for example, in the memory 215 of the tracking device controller 200 or alternatively in an external memory or database accessible to the tracking device controller 200. The stored locations may be or include shipping destinations, such as PO Boxes, FedEx or UPS drop boxes, or Amazon drop boxes. Additionally or alternatively, the stored locations may include government buildings, financial institutions, airports, or any final destination for a package. The stored locations may be stored by their longitude and latitude or GPS coordinates.

In step 530, the tracking device controller 200 identifies the location of the wireless tracking device 400 as one of the stored locations identified in step 520. Accordingly, the tracking device controller 200 has determined that the wireless tracking device 400 is located at a PO Box or other shipping drop box or any other stored location. Other stored locations may, for example, include destination locations. For example, if a package has reached its intended destination, whether that destination is a street address, a drop box or PO Box, an airport, or any other location, tracking may become undesirable when an object has reached its destination.

Upon making the determination in step 530 that the wireless tracking device 400 is at a stored location, the tracking device controller 200 monitors the tracking device 400 for movement in step 540. In step 550, the tracking device controller 200 detects movement of the wireless tracker 400 from the location that has been determined to match a stored location.

Responsive to the detection of movement in step 550, the tracking device controller 200 sends an instruction for the wireless tracking device 400 to generate an alert in step 560. The instruction may be sent to the access node 330 or directly to the wireless tracking device 400 depending on the location of the tracking device controller 200. In embodiments set forth herein, the instruction is sent to the tracking device 400 from the access node 330. The instruction may cause the wireless tracking device 400 to vibrate, generate a beep, audio tone, or other sound, or generate a visual alert such as a flashing light. Further in some embodiments, when the stored location is a shipping drop box, the wireless tracking device 400 may attempt to alert the package carrier of the presence of the tracker via a Bluetooth broadcast that an external device assigned to the shipper will detect. The external device could be, for example, a mobile phone with appropriate software or another specialized electronic device.

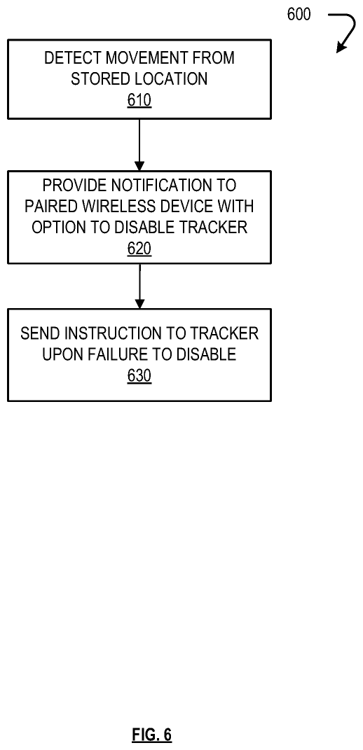

FIG. 6 illustrates a further method 600 for controlling a tracking device in accordance with embodiments set forth herein. In particular, the method 600 illustrates a method for additionally interacting with a wireless device 160a, 160b prior to causing generation of an alert. Method 600 may be performed by a processor, for example, the processor 270 in the tracking device controller 200. Alternatively, the steps may be performed by a processor of an access node 330, or another processor in the system. For the sake of illustration, the method is described as being performed by the processor 270.

Method 600 starts in step 610, when the tracking device controller 200 detects movement of the tracking device 400a, 400b from the location that matches the stored location. Upon detection of movement in step 610, the tracking device controller 200 provides a notification to the wireless device 160a, 160b paired with the tracking device 400 in step 620. Preferably, the notification includes an option and/or recommendation for the user of the wireless device 160a, 160b to disable the wireless tracking device 400 to avoid tracking of an individual without consent.

For example, the stored location may be a PO box, and the individual picking up the package may be moving it to a confidential residential address. The tracking device 400 must be disabled in order to avoid disclosure of the confidential residential address. Because of the lack of consent, upon failure of the user of the wireless device 160a, 160b to disable the tracker, a further method step may include sending an instruction to the tracker 400 in order to generate an alert in step 630. In embodiments set forth herein, the tracking device controller 200 or the access node 330 may send the instruction to the tracking device to generate the alert within a predetermined stored time period after sending the notification to the paired wireless device 160a, 160b.

Further, in some embodiments, the user of the wireless device 160a, 160b may be able to verify that continued tracking has a legitimate purpose through a mobile app on the wireless device 160a, 160b. In this instance, the generation of alerts by the tracking device controller 200 may be avoided.

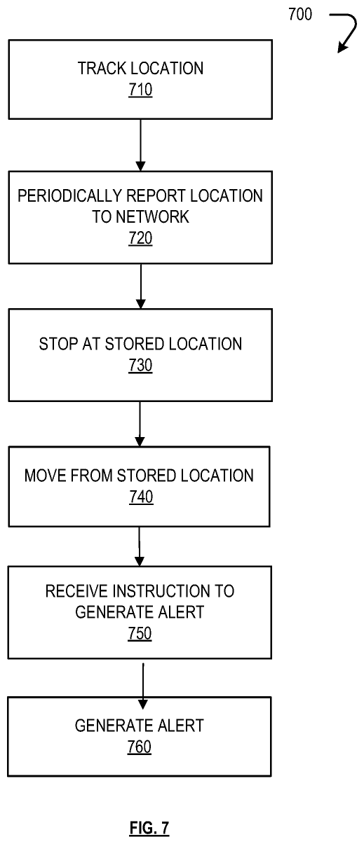

FIG. 7 illustrates a further method 700 for controlling a tracking device 400a, 400b in accordance with embodiments set forth herein. In particular, the method 700 illustrates a method performed by the tracking device 400 causing generation of an alert. Method 700 may be performed by a processor, for example, the processor 432 in the wireless tracking device 400. For the sake of illustration, the method is described as being performed by the processor 432.

Method 700 starts in step 710, when the processor 432 of the wireless tracking device 400 tracks the location of the wireless tracking device. In step 720, the wireless tracking device periodically reports its location to the network. For example, the wireless tracking device 400 may report its location to an access node 330 or to the tracking device controller 200.

In step 730, the wireless tracking device 400 stops moving. In some instances, the stop at step 730 may be at a stored location as detected by the tracking device controller 200. Subsequently, in step 730, the wireless tracking device 400 moves from the stored location.

In response to the movement from the stored location in step 740, the wireless tracking device 400 receives an instruction to generate an alert in step 750. The instruction may be received from, for example, the tracking device controller 200. Responsive to the instruction, the wireless tracking device 400 generates an alert in step 760. The alert may be generated repeatedly so as notify an individual or entity of unauthorized tracking. In some embodiments, the alert may be generated at regular intervals and may terminate only when a tracker batter is exhausted or when an individual manually disables the wireless tracking device 400.

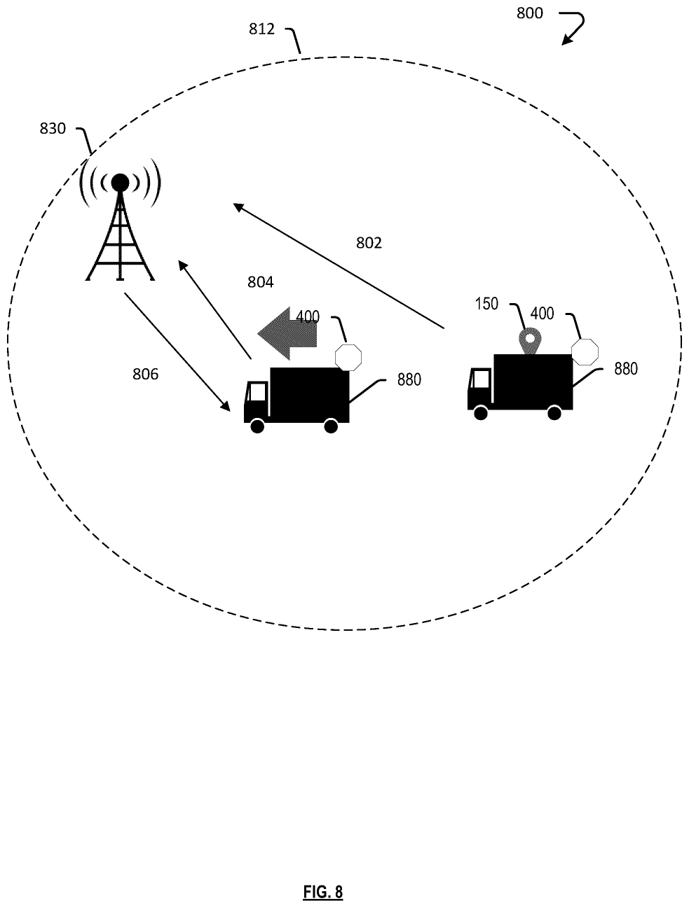

FIG. 8 provides an example 800 of the scenario described above with respect to FIG. 5. In FIG. 8, an access node 830 may deploy a coverage area 812 and may include or communicate with a tracking device controller 200. A wireless tracking device 400 may be on a transport vehicle 880 and may stop at a location 150. The wireless tracking device 400, while stopped at the location 150 may send coordinates or location information at 802 to the access node 830. In response, the tracking device controller 200 determines that the location 150 is a stored location, such as a shipping drop box.

At some point, the transport vehicle 880 carrying the wireless tracking device 400 may move from the location 150 and may again transmit location information or coordinates to the access node 830 at 804. In response to detecting the movement indicated through the transmission 804, the access node 830 may transmit an instruction from the tracking device controller 200 to cause generation of an alert on the tracking device 400.

Accordingly, methods provided herein provide improved tracking device control in order to avoid tracking individuals or entities without consent. In some embodiments, methods 500, 600, 700, and 800 may include additional steps or operations. Furthermore, the methods may include steps shown in each of the other methods. As one of ordinary skill in the art would understand, the methods 500, 600, 700, and 800 may be integrated in any useful manner.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

The methods, systems, devices, networks, access nodes, and equipment described herein may be implemented with, contain, or be executed by one or more computer systems and/or processing nodes. The methods described above may also be stored on a non-transitory computer readable medium. Many of the elements of the exemplary environment 100 may be, comprise, or include computers systems and/or processing nodes, including access nodes, controller nodes, and gateway nodes described herein.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
receiving, at an access node of a wireless network, a signal indicating a location from a tracking device;
comparing the location to stored locations;
identifying the location as one of the stored locations;
monitoring the tracking device for movement from the location; and
responsive to detecting the movement from the stored location, sending an instruction to the tracking device to generate an alert while the tracking device is enabled.

2. The method of claim 1, further comprising, responsive to detecting the movement from the location, providing a notification to a wireless device paired with the tracking device, the notification including an option to disable the tracking device.

3. The method of claim 2, further comprising sending the instruction to the tracking device to generate the alert within a predetermined time after sending the notification to the paired wireless device.

4. The method of claim 1, further comprising maintaining a database of the stored locations at the access node.

5. The method of claim 1, further comprising sending the instruction to the tracking device from the access node.

6. The method of claim 1, wherein the signal indicating the location includes global positioning system (GPS) coordinates.

7. The method of claim 1, wherein the stored locations include at least one of a post office box or a shipping drop box.

8. The method of claim 1, wherein the stored locations include a destination location.

9. The method of claim 1, wherein the alert is one of an audio tone, a vibration, or a flashing light.

10. A system comprising:
a memory storing data and instructions;
a transceiver, receiving a signal indicating a location of a tracking device;
a processor accessing the memory to execute the stored instructions and perform operations including;
comparing the location to stored locations in the memory;
identifying the location as one of the stored locations;
monitoring the tracking device for movement from the location; and
responsive to detecting movement from the stored location, sending an instruction to the tracking device to generate an alert.

11. The system of claim 10, the operations further comprising, responsive to detecting movement from the location, providing a notification to a wireless device paired with the tracking device, the notification including an option to disable the tracking device.

12. The system of claim 11, the operations further comprising sending the instruction to the tracking device to generate the alert upon failure to disable the tracking device.

13. The system of claim 11, the operations further comprising sending the instruction to the tracking device to generate the alert within a predetermined time after sending the notification to the paired wireless device.

14. The system of claim 10, further a database of the stored locations.

15. The system or of claim 10, wherein the signal indicating the location includes global positioning system (GPS) coordinates.

16. The system of claim 10, wherein the stored locations include at least one of a post office box or shipping drop box.

17. An access node comprising:
a memory storing data and instructions;
a transceiver, receiving a signal indicating a location of a tracking device;
a processor accessing the memory to execute the stored instructions and perform operations including;
comparing the location to stored locations in the memory;
identifying the location as one of the stored locations;
monitoring the tracking device for movement from the location; and
responsive to detecting movement from the location, generating an instruction for the tracking device to generate an alert.

18. The access node of claim 17, the operations further comprising responsive to detecting movement from the location, providing a notification to a wireless device paired with the tracking device, the notification including an option to disable the tracking device.

19. The access node of claim 17, the operations further comprising generating the instruction for the tracking device responsive to a failure to disable the tracking device.

20. The access node of claim 17, the stored locations comprising at least one of a post office box or a shipping drop box.
